(19) United States
(12) Patent Application Publication
(10) Pub. No.: US 2006/0197868 A1
(43) Pub. Date: Sep. 7, 2006

(54) Apparatus for interpolating scanning line and method thereof

(75) Inventor: Hiroki Ogo, Tokyo (JP)

Correspondence Address: GLOBAL IP COUNSELORS, LLP, 1233 20TH STREET, NW, SUITE 700, WASHINGTON, DC, 20036-2680, US

(73) Assignee: OKI ELECTRIC INDUSTRY CO., LTD., Tokyo (JP)

(21) Appl. No.: 11/164,490

(22) Filed: Nov. 25, 2005

(30) Foreign Application Priority Data
Nov. 25, 2004 (JP) 2004-339764

(51) Int. Cl. H04N 11/20

(52) U.S. Cl. 348/448

(57) ABSTRACT

An apparatus and method for interpolating a scanning line is disclosed which carries out scanning line conversion of a picture signal of an interlace system to a picture signal of a progressive system by generating an interpolation pixel from the picture signal of an interlace system. This apparatus includes first and second line memories, first and second difference value calculation units, a threshold setting unit, a difference value comparing unit, and an interpolation processing unit. The apparatus and method disclose in this application make it possible to prevent erroneous detection of the picture angle. Furthermore, since the apparatus and method does not require line memories other than two line memories for storing the upper and lower scanning line signals of the scanning lines to be interpolated, it is possible to prevent the control system from becoming complicated.

### BACKGROUND OF THE INVENTION

1. Field of the Invention

The present invention relates to a scanning line interpolation apparatus and a method of interpolating a scanning line, which in particular can carry out scanning line conversion of a picture signal of an interlace system to a picture signal of a progressive system.

2. Background Information

In general, in order to change a picture signal of an interlaced scanning system into a picture signal of a progressive scanning (non-interlaced scanning) system, an interpolation device for performing interpolation processing of scanning lines is used. In this type of scanning line interpolation apparatus, the value of an interpolation pixel (i.e. a pixel which should be produced by the interpolation processing) is calculated based on the values of pixels around the interpolation pixel. For example, with respect to a picture with an edge or a picture with thin lines, the angle of the picture is detected based on the luminance distribution of the surrounding pixels and the value of the interpolation pixel is calculated using the pixel which exists in the direction with higher correlation. Therefore, a scanning line interpolation apparatus is usually equipped with a picture angle detection device for detecting the angle of a picture displayed by a picture signal.

For example, one patent reference (Japanese Laid Open Patent Application No. 2003-52023, pp. 13-16, FIG. 1) discloses such scanning line interpolation apparatus having a picture angle detection device. In the picture angle detection device of the scanning line interpolation apparatus introduced by this patent reference, the pixels within a correlation determination region (hereinafter to be referred to as a ‘detection window’) which has an interpolation pixel in its center are binary coded, and compared with a plurality of reference patterns given by a reference pattern generation section by which the picture angle around the interpolation pixel is detected. Due to this arrangement, interpolation precision is improved with respect to a picture having an edge in the oblique direction or a picture with thin oblique lines.

With respect to a conventional scanning line interpolation apparatus, with a picture angle detection device, the difference between two pixels in each of the upper and lower directions and the oblique directions, where an interpolation pixel is set at the center, is calculated, and based on this calculated difference value, the degree of correlation is determined. However, with such a determination method based on the difference in value between two pixels, there is a possibility that mistakes in determination may occur.

In the scanning line interpolation apparatus of the patent reference, the picture angle detection device uses at least three line memories in the series of processes for detecting the picture angle. Generally, a line memory should be controlled individually, and therefore, increasing the number of line memories might complicate the control system.

In view of the above, it will be apparent to those skilled in the art from this disclosure that there exists a need for an improved scanning line interpolation apparatus and a method of interpolating scanning lines. This invention addresses this need in the art as well as other needs, which will become apparent to those skilled in the art from this disclosure.

### SUMMARY OF THE INVENTION

It is therefore an object of the present invention to resolve the above-described problems, and to provide a scanning line interpolation apparatus and a method of interpolating scanning lines which can detect a picture angle with precision and without having to complicate the control system.

In accordance with one aspect of the present invention, an apparatus for interpolating a scanning line, which carries out scanning line conversion of a picture signal of an interlace system to a picture signal of a progressive system by generating an interpolation pixel from the picture signal of an interlace system, has first and second line memories, first and second difference value calculation units, a threshold setting unit, a difference value comparing unit, and an interpolation processing unit. The first line memory stores a first scanning line. The second line memory stores a second scanning line which is one horizontal synchronization period before the first scanning line. The first difference value calculation unit calculates a first difference value between a first pixel of the first scanning line and a second pixel of the second scanning line in a predetermined determination region including a plurality of pixels of the first and second scanning lines. The first pixel and the second pixel are symmetrical with respect to the interpolation pixel. The threshold setting unit sets a predetermined threshold. The second difference value calculation unit calculates a second difference value by adding weight to the first difference value based on the predetermined threshold which is being set by the threshold setting unit. The difference value comparing unit identifies a minimum value among the second difference values and generates angle information which shows the calculation direction of the second difference value corresponding to the minimum value. The interpolation processing unit receives the angle information, obtains an average of the first pixel of the first scanning line and the second pixel of the second scanning line in the direction corresponding to the angle information, and generates an interpolation value using the average.

In accordance with another aspect of the present invention, a method for interpolating a scanning line, which carries out scanning line conversion of a picture signal of an interlace system to a picture signal of a progressive system by generating an interpolation pixel from the picture signal of an interlace system, comprising the steps of: storing a first scanning line; storing a second scanning line which is one horizontal synchronization period before the first scanning line; calculating a first difference value between a first pixel of the first scanning line and a second pixel of the second scanning line in a predetermined determination region including a plurality of pixels of the first and second scanning lines, the first pixel and the second pixel being symmetrical with respect to the interpolation pixel; setting a predetermined threshold; calculating a second difference value by adding weight to the first difference value based on the predetermined threshold; identifying a minimum value among the second difference values; generating angle information which shows a calculation direction of the second difference value corresponding to the minimum value; obtaining an average of the first pixel of the first scanning line and the second pixel of the second scanning line in the direction corresponding to the angle information; and generating an interpolation value using the average.

These and other objects, features, aspects, and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is a diagram showing a structure of a scanning line interpolation apparatus according to one embodiment of the present invention;

FIG. 2 is a diagram showing picture pixels and a detection window;

FIG. 3A is a diagram showing an example of picture angle detection and scanning line interpolation using threshold values; and

FIG. 3B is a diagram showing another example of picture angle detection and scanning line interpolation using threshold values.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

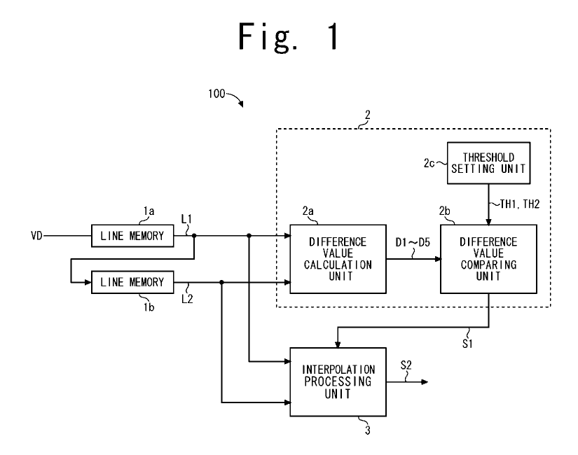

FIG. 1 is a diagram showing a structure of a scanning line interpolation apparatus according to one embodiment of the present invention.

A scanning line interpolation apparatus 100 includes line memories 1a and 1b, a picture angle detection unit 2 and an interpolation processing unit 3. Furthermore, the picture angle detection unit 2 has a difference value calculation unit 2a, a difference value comparing unit 2b and a threshold setting unit 2c.

The line memory 1a (first line memory) stores a picture signal VD for a single scanning line and outputs it as a scanning line signal L1 (first scanning line) at every horizontal synchronization period. The line memory 1b (second line memory) stores the scanning line signal L1 received from the line memory 1a and outputs it as a scanning line signal L2 (second scanning line) at every horizontal synchronization period. Accordingly, there is a time lag of one horizontal synchronization period between the scanning line signal L1 outputted by the line memory 1a and the scanning line signal L2 outputted by the line memory 1b. In other words, the second scanning line signal L2 is one horizontal synchronization period before the scanning line signal L1.

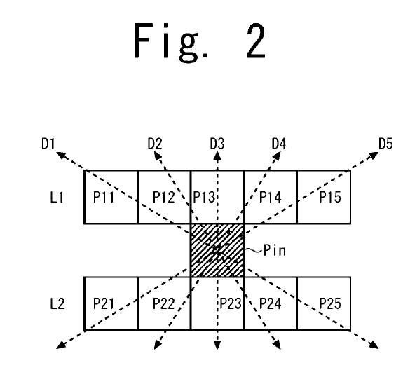

The difference value calculation unit 2a (first difference value calculation unit) receives the scanning line signal L1 outputted by the line memory 1a and the scanning line signal L2 outputted by the line memory 1b, and calculates the difference of luminance (first difference value) between a pixel (first pixel) of the scanning line signal L1 and a pixel (second pixel) of the scanning line signal L2 with respect to a detection window (i.e. a correlation determination region where an interpolation pixel is set at the center). Hereinafter the difference of luminance is referred to as ‘difference value’. Here, as shown in FIG. 2, the detection window is a 5×2-pixel rectangular region which includes an interpolation pixel Pin at the center, five pixels of the scanning line L1 and five pixels of the scanning line L2. However, the size of the detection window does not have to be 5×2 pixels. For instance, the detection window can be a 7×2-pixel rectangular region which includes seven pixels of the scanning line L1 and seven pixels of the scanning line L2. In the description of this particular embodiment, the size of the detection window will be 5×2 pixels.

As shown in FIG. 2, in the 5×2-pixel detection window, there can be five pairs of upper and lower pixels which are symmetric with respect to the interpolation pixel Pin at the center, and the five possible pairs are (P11, P25), (P12, P24), (P13, P23), (P14, P22), and (P15, P21). Accordingly, there are five ways to calculate five difference values (i.e. D1 to D5) at the difference value calculation unit 2a. The five possible difference values are D1=|P11−P25|, D2=|P12−P24|, D3=|P13−P23|, D4=|P14−P22|, and D5=|P15−P21|.

First, the difference value comparing unit 2b (second difference value calculation unit and difference value comparing unit) receives the difference values D1 to D5 which have been calculated at the difference value calculation unit 2a, and corrects the difference values D1 to D5 using threshold values TH1 (first threshold) and TH2 (second threshold) having been set by the threshold setting unit 2c. Correcting of the difference values D1 to D5 in this case means adding the threshold value TH1 or TH2 to the difference values D1 to D5, respectively, to add weight. To be more precise, considering that the magnitude relation between the threshold values TH1 and TH2 is TH1<TH2, the difference values D1 to D5 are changed into the following values: D1′=D1+TH2, D2′=D2+TH1, D3′=D3 (no weight added), D4′=D4+TH1, and D5=D1+TH2. Accordingly, more weight is added to the difference value of a pair of pixels which are farther apart from the interpolation pixel Pin. In this case, the threshold values TH1 and TH2 may be set in advance at the threshold setting unit 2c as fixed values, or may be set from exterior by software. The effects of such weight addition using the threshold values TH1 and TH2 will be explained later on.

Next, the difference value comparing unit 2b determines the minimum value among the weight-added difference values D1′ to D5′ (second difference value), identifies the direction which corresponds to the minimum value as angle information S1 and outputs it to the interpolation processing unit 3. In this case, the angle information S1 is given as flag information (1, 2, 3, 4, or 5) corresponding to the calculation direction of the weight-added difference value (D1′, D2′, D3′, D4′ or D5′). For example, if the difference value D1′ was determined as the minimum value, the angle information S1 would be ‘1’. Likewise, if the difference value D2′ was determined as the minimum value, the angle information S1 would be ‘2’, if the difference value D3′ was determined as the minimum value, the angle information S1 would be ‘3’, if the difference value D4′ was determined as the minimum value, the angle information S1 would be ‘4’, and if the difference value D5′ was determined as the minimum value, the angle information S1 would be ‘5’.

On the basis of the angle information S1 received from the difference value comparing unit 2b, the interpolation processing unit 3 selects one direction from among five directions shown in FIG. 2 and calculates the average value between the two pixels in that direction which are symmetric with respect to the interpolation pixel Pin. Then the interpolation processing unit 3 outputs this average value as an interpolation value S2. For instance, if flag information ‘1’ is received from the difference value comparing unit 2b as the angle information S1, the interpolation processing unit 3 calculates the average value between the two pixels (i.e. P11 and P25) in the direction of D1 shown in FIG. 2, and outputs the calculation result as the interpolation value S2.

Next, the effects of weight addition by the threshold values TH1 and TH2 will be explained using some examples.

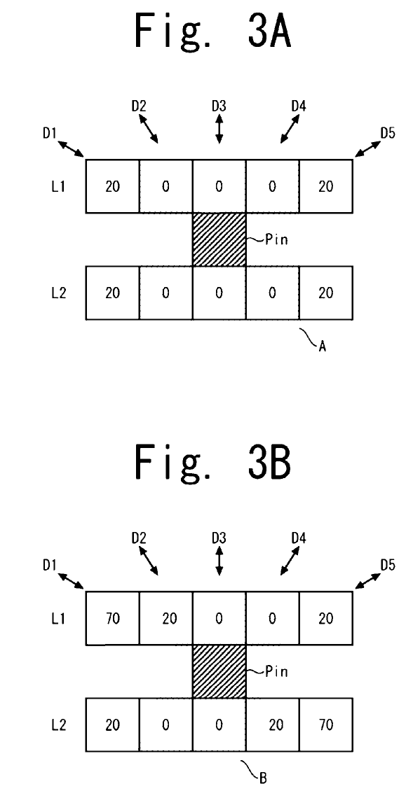

A first example will be explained with reference to FIG. 3A. As shown in FIG. 3A, there is an image pattern A whose edges intersect with a 5×2-pixel detection window approximately at right angles. In FIG. 3A, the number given to each pixel shows the luminance of the pixel. Luminance is usually expressed with a 256 (0˜255)-gradation sequence, and the larger the number of the pixel is, the brighter it becomes. Calculations for determining the difference of luminance between two pixels in the five directions (D1 to D5), respectively, are as follows: D1=20−20=0, D2=0−0=0, D3=0−0=0, D4=0−0=0, and D5=20−20=0. Accordingly, the difference values become ‘0’ with respect to all five directions. At this point, it is not possible to determine which direction is correlative. One measure is to select the direction of D3 which has the least error, but when there are slight changes in the picture due to noises etc., the direction of D1 or D5 may be selected, and this results in misdetection of the image angle.

In order to resolve this problem, weight is added to each of the difference values D1 to D5 by the threshold value TH1 or TH2. In this example, the magnitude relation between the threshold values TH1 and TH2 is to be TH1<TH2, and for example, TH1 is given the value ‘5’ while TH2 is given the value ‘10’. Under these conditions, the difference values D1′ to D5′ to which weights are added using the threshold values TH1 and TH2 would be calculated as follows: D1′=D1+TH2=0+10=10, D2′=D2+TH1=0+5=5, D3′=D3=0, D4′=D4+TH1=0+5=5, and D5′=D1+TH2=0+10=10. Accordingly, the difference value in the direction of D3 (D3′) would be the minimum. By this process, the direction of D3 is selected, and the average value ‘0’ between the two pixels corresponding to the direction of D3 is to be inputted to the interpolation pixel Pin.

A second example will be explained with reference to FIG. 3B. As shown in FIG. 3B, there is an image pattern B whose edges intersect diagonally with a 5×2-pixel detection window. Calculations for determining the difference of luminance between two pixels in the five directions (D1 to D5), respectively, are as follows: D1=70−70=0, D2=20−20=0, D3=0−0=0, D4=0−0=0, and D5=20−20=0. Accordingly, the difference values become ‘0’ with respect to all five directions. At this point, it is not possible to determine which direction is correlative.

In order to resolve this problem, weight is added to each of the difference values D1 to D5 by the threshold value TH1 or TH2. In this example, the magnitude relation between the threshold values TH1 and TH2 is to be TH1<TH2, and for example, TH1 is given the value ‘5’ while TH2 is given the value ‘10’. Under these conditions, the difference values D1′ to D5′ to which weights are added using the threshold values TH1 and TH2 would be calculated as follows: D1′=D1+TH2=0+10=10, D2′=D2+TH1=0+5=5, D3′=D3=0, D4′=D4+TH1=0+5=5, and D5′=D1+TH2=0+10=10. Accordingly, the difference value in the direction of D3 (D3′) would be the minimum. By this process, the direction of D3 is selected, and the average value ‘0’ between the two pixels corresponding to the direction of D3 is to be inputted to the interpolation pixel Pin.

According to the scanning line interpolation apparatus 100 of the embodiment of the present invention, in detecting the picture angle at the picture angle detection unit 2, weight is added to the difference values D1 to D5, which have been calculated with respect to the pixels within the detection window, using the threshold values TH1 or TH2. By this arrangement, it is made possible to prevent erroneous detection of the picture angle. Furthermore, since the apparatus does not require extra line memories besides the two line memories for storing the upper and lower scanning line signals of the scanning lines to be interpolated, it is possible to prevent the control system from becoming complicated.

While the preferred embodiment of the invention has been described using specific terms, such description is for illustrative purposes only, and it is to be understood that changes and variations may be made without departing from the spirit or the scope of the following claims.

This application claims priority to Japanese Patent Application No. 2004-339764. The entire disclosures of Japanese Patent Application No. 2004-339764 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

What is claimed is:

1. An apparatus for interpolating a scanning line, which carries out scanning line conversion of a picture signal of an interlace system to a picture signal of a progressive system by generating an interpolation pixel from the picture signal of an interlace system, comprising:
a first line memory storing a first scanning line;
a second line memory storing a second scanning line which is one horizontal synchronization period before the first scanning line;
a first difference value calculation unit calculating a first difference value between a first pixel of the first scanning line and a second pixel of the second scanning line in a predetermined determination region including a plurality of pixels of the first and second scanning lines, the first pixel and the second pixel being symmetrical with respect to the interpolation pixel;
a threshold setting unit setting a predetermined threshold;
a second difference value calculation unit calculating a second difference value by adding weight to the first difference value based on the predetermined threshold which is being set by the threshold setting unit;
a difference value comparing unit identifying a minimum value among the second difference values and generating angle information which shows a calculation direction of the second difference value corresponding to the minimum value; and
an interpolation processing unit receiving the angle information, obtaining an average of the first pixel of the first scanning line and the second pixel of the second scanning line in the direction corresponding to the angle information, and generating an interpolation value using the average.

2. The apparatus for interpolating a scanning line according to claim 1, wherein
the second difference value calculation unit adds greater weight to the first difference value as a distance from the interpolating pixel to the first and second pixels in the predetermined determination region becomes larger.

3. The apparatus for interpolating a scanning line according to claim 1, wherein
the predetermined determination region is a rectangular region including five pixels in the first scanning line and five pixels in the second scanning line.

4. The apparatus for interpolating a scanning line according to claim 3, wherein
the second difference value calculation unit adds a first threshold to a first difference value of the pixel which is second most separated from the interpolation pixel in the predetermined determination region, and adds a second threshold to a first difference value of the pixel which is most separated from the interpolation pixel in the predetermined determination region, the second threshold being larger than the first threshold.

5. A method for interpolating a scanning line, which carries out scanning line conversion of a picture signal of an interlace system to a picture signal of a progressive system by generating an interpolation pixel from the picture signal of an interlace system, comprising the steps of:
storing a first scanning line;
storing a second scanning line which is one horizontal synchronization period before the first scanning line;
calculating a first difference value between a first pixel of the first scanning line and a second pixel of the second scanning line in a predetermined determination region including a plurality of pixels of the first and second scanning lines, the first pixel and the second pixel being symmetrical with respect to the interpolation pixel;
setting a predetermined threshold;
calculating a second difference value by adding weight to the first difference value based on the predetermined threshold;
identifying a minimum value among the second difference values;
generating an angle information which shows a calculation direction of the second difference value corresponding to the minimum value;
obtaining an average of the first pixel of the first scanning line and the second pixel of the second scanning line in the direction corresponding to the angle information; and
generating an interpolation value using the average.

6. The method for interpolating a scanning line according to claim 5, wherein
the second difference value is calculated by adding greater weight to the first difference value as a distance from the interpolating pixel to the first and second pixels in the predetermined determination region becomes larger.

7. The method for interpolating a scanning line according to claim 5, wherein
the predetermined determination region is a rectangular region including five pixels in the first scanning line and five pixels in the second scanning line.

8. The method for interpolating a scanning line according to claim 7, wherein
the second difference value of the pixel which is second most separated from the interpolation pixel in the predetermined determination region is calculated by adding a first threshold to a first difference value of the pixel,
the second difference value of the pixel which is most separated from the interpolation pixel in the predetermined determination region is calculated by adding a second threshold to a first difference value of the pixel, and
the second threshold is larger than the first threshold.
